(19) United States
(12) Patent Application Publication
(10) Pub. No.: US 2017/0236403 A1
(43) Pub. Date: Aug. 17, 2017

(54) SYSTEMS AND METHODS OF LOCATION BASED AWARENESS OF LIFE SAFETY SENSORS

(71) Applicant: Honeywell International Inc., Morristown, NJ (US)

(72) Inventors: Bin Yang, Shanghai (CN); Xiaoguang Zhao, Shanghai (CN); Hongye Jiang, Shanghai (CN)

(21) Appl. No.: 15/044,417

(22) Filed: Feb. 16, 2016

(51) Int. Cl. G08B 25/10

(52) U.S. Cl. CPC G08B 25/10

(57) ABSTRACT

Systems and methods of location based awareness of life safety sensors are provided. Some methods can include detecting an ambient emergency condition, and, responsive to detecting the ambient emergency condition, transmitting a wireless beacon signal, wherein a range into which the wireless beacon signal is transmitted is limited, and wherein a signal strength of the wireless beacon signal progressively decreases from a first part of the range, adjacent a source of the wireless beacon signal, to a second part of the range, displaced from the source of the wireless beacon signal. Additionally or alternatively, some methods can include receiving the wireless beacon message from a sensor device, determining the signal strength of the wireless beacon message, and based on the signal strength, determining the range of the sensor device.

### FIELD

The present invention relates generally to life safety sensors. More particularly, the present invention relates to systems and methods of location based awareness of life safety sensors.

### BACKGROUND

When an ambient or life safety condition, such as smoke, carbon monoxide, or other poisonous gas, is detected by a sensor in a monitored region, such as a building or warehouse, there are no know systems and methods to indicate to users the location of the emergency condition within the region. For example, when a sensor detects such an emergency condition, the active sensor may join a one-go-all-go protocol such that all sensors, detectors, sirens, or bells in the monitored region are activated to indicate to users that there is an emergency condition in the monitored region. However, users, such as occupants of the region or emergency personnel reporting to the region, have no way to know the location of the emergency condition within the region so as to avoid the location when exiting the region or so as to find the location when arriving in the region to address the emergency condition. Indeed, if a user in an immediate vicinity of an emergency condition could know of the nearby alarm condition in a timely manner, the user attempting to exit the region could more effectively escape from the emergency condition and the user attempting to address the emergency condition could more effective take the necessary actions.

In view of the above, there is a continuing, ongoing need for improved systems and methods.

### BRIEF DESCRIPTION OF THE DRAWINGS

FIG. 1 is a flow diagram of a method in accordance with disclosed embodiments;

FIG. 2 is a block diagram of a system in accordance with disclosed embodiments;

FIG. 3 is a block diagram of an exemplary sensor device and user devices in immediate, near, far, and unknown ranges of the sensor device in accordance with disclosed embodiments; and

FIG. 4 is a floor plan of a monitored region in accordance with disclosed embodiments.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein can include systems and methods of location based awareness of life safety sensors. For example, sensors in accordance with disclosed embodiments can transmit a wireless beacon signal to establish a region around the sensor. In some embodiments, the wireless beacon signal can include an iBeacon signal, a Bluetooth Low Energy (BLE) advertising message, and the like. However, it is to be understood that embodiments disclosed herein are not so limited and could include any additional or alternative wireless beacon signal as would be known and desired by one of ordinary skill in the art.

Electronic user devices, such as smart phones, wearable devices, or other BLE capable devices, within a monitored region that includes sensors as disclosed herein, can receive the wireless beacon signal transmitted by the sensor. Based on the signal strength of the received wireless beacon signal, the user device can identify the range level of the sensor that transmitted the wireless beacon signal and thereby determine whether the sensor transmitting the wireless beacon signal is in an immediate, near, or far range relative to the user device.

In accordance with disclosed embodiments, a sensor operating in a normal condition can abstain from transmitting a wireless beacon signal. However, upon detection of an emergency condition, the sensor can enable a wireless beacon signal transmitting module for broadcasting or transmitting a wireless beacon signal. In some embodiments, the sensor can transmit the wireless beacon signal for a predetermined period of time, until the sensor fails to detect the emergency condition for a predetermined period of time after detecting the emergency condition, or until the sensor receives user input with instructions to cease transmitting the wireless beacon signal.

Electronic user devices within range of the sensor can detect and receive the wireless beacon signal advertising the sensor. Upon detection and reception, the user device can identify a range level of the sensor that transmitted the wireless beacon signal based on the signal strength of the received signal. The user device can also decode the wireless beacon signal to identify information advertised by the sensor, including the type of emergency condition detected by the sensor.

It is known that wireless beacon signals, such as BLE advertising, have a limited range. Accordingly, when a user device detects a wireless beacon signal as disclosed herein, regardless of the identified range level, it can be understood that the user device is close to an emergency zone in which the sensor transmitting the wireless beacon signal is located. As a user moves throughout a monitored region, either to avoid an emergency zone, to exit the region, or to enter the emergency zone to address the emergency condition, the user can determine his location relative to the emergency zone or the sensor that detected the emergency condition according to whether the user's electronic device receives a wireless beacon message and further, the range level of any received wireless beacon message. For a user trying to avoid an emergency zone or to exit a region, the user can understand that he should try a different route or go in another direction when he receives a wireless beacon signal with any range level. For a user trying to enter an emergency zone to address an emergency condition, the user can assess a determined range level of a received wireless beacon signal to determine whether he is far, near, or immediate relative to the emergency zone and that he should move along a same route or in a same direction as he becomes nearer or more immediate to the emergency zone.

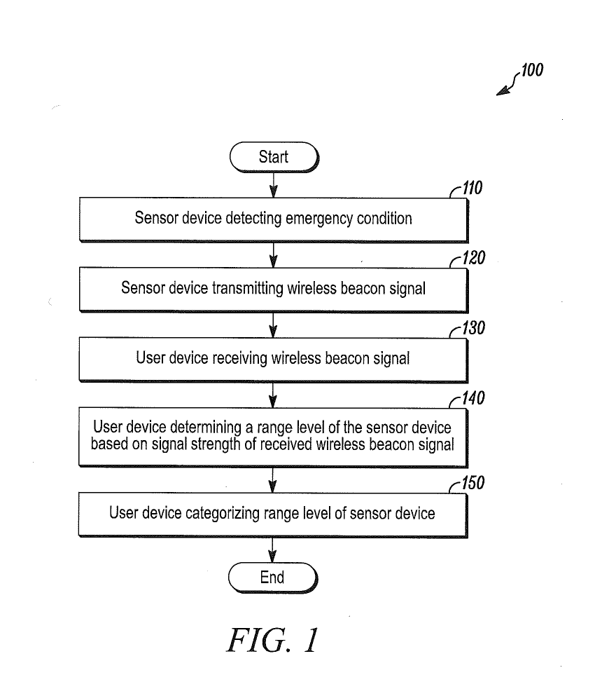

FIG. 1 is a flow diagram of a method 100 in accordance with disclosed embodiments. As seen in FIG. 1, the method 100 can include a sensor device detecting an emergency condition as in 110 and responsive thereto, transmitting a wireless beacon signal as in 120. The method 100 can also include a user device within range of the sensor device receiving the wireless beacon signal as in 130 and responsive thereto, determining a range level of the sensor device based on the signal strength of the received wireless beacon signal as in 140. The method 100 can also include the user device categorizing the range level of the sensor device as in 150, for example, as immediate, near, or far and in some embodiments, providing a notification to the user thereof.

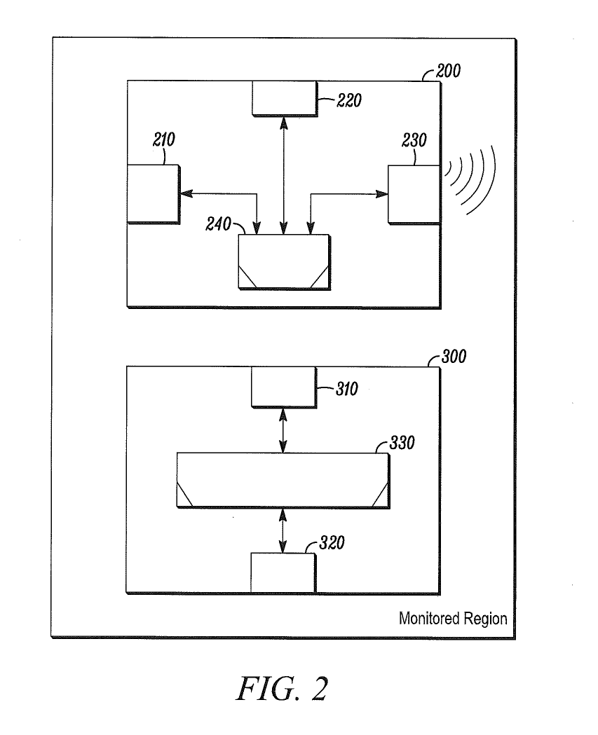

FIG. 2 is a block diagram of a system in accordance with disclosed embodiments. As seen in FIG. 2, the system can include a sensor device 200 and a user device 300 in a monitored region.

The sensor device 200 can include a detection module 210, a wired or wireless alarm reporting module 220, and a wireless beacon signal transceiver 230, each of which can be in bidirectional communication with a microcontroller unit 240. It is to be understood that the microcontroller unit 240 can include control circuitry, one or more programmable processors, and executable control software as would be understood by those of ordinary skill in the art. The executable control software can be stored on a transitory or non-transitory computer readable medium, including, but not limited to, local computer memory, RAM, optical storage media, magnetic storage media, flash memory, and the like. In some embodiments, the microcontroller unit 240, including the control circuitry, the programmable processor, and the control software can execute and control some of the methods describe above and herein.

For example, when the detection module 210 detects an emergency condition, the microcontroller unit 240 can report an alarm via the alarm reporting module 220 and activate the wireless beacon signal transceiver 230 for transmission of a wireless beacon message. In some embodiments, the wireless beacon message can include information related to the sensor device 200 or the emergency condition detected by the detection module 210.

Similarly, the user device 300 can include a wireless beacon signal transceiver 310 and a user interface device 320, each of which can be in bidirectional communication with a microcontroller unit 330. It is to be understood that the microcontroller unit 330 can include control circuitry, one or more programmable processors, and executable control software as would be understood by those of ordinary skill in the art. The executable control software can be stored on a transitory or non-transitory computer readable medium, including, but not limited to, local computer memory, RAM, optical storage media, magnetic storage media, flash memory, and the like. In some embodiments, the microcontroller unit 330, including the control circuitry, the programmable processor, and the control software can execute and control some of the methods describe above and herein.

For example, when the transceiver 310 detects a wireless beacon signal transmitted by the sensor device 200, the microcontroller unit 330 can identify the signal strength of the received signal and based thereon, determine the range of the sensor device 200 and categorize the determined range, for example, as immediate, near, or far. In some embodiments, the microcontroller unit 330 can decode the received wireless beacon signal to identify information about the sensor device 200 or the emergency condition detected by the sensor device 200. In some embodiments, the user interface device 320 can display or emit an indication to a user regarding the determined range of the sensor device 200.

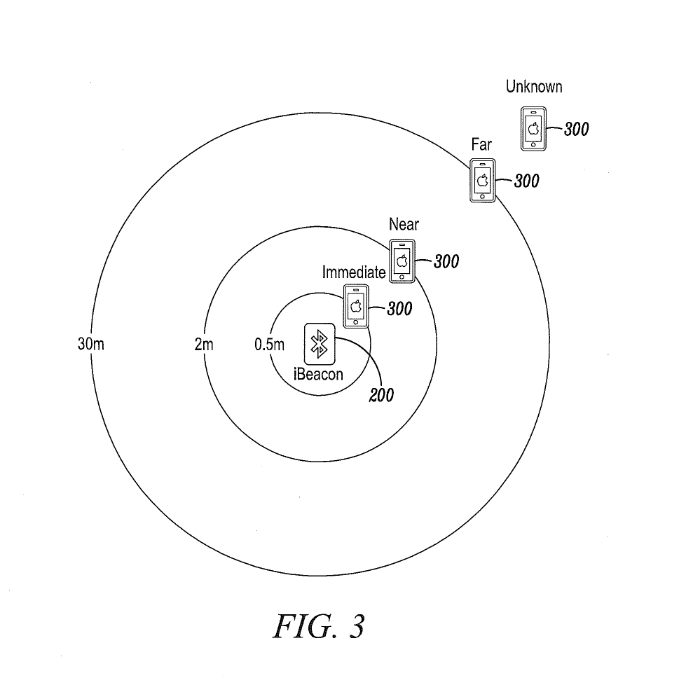

FIG. 3 is a block diagram of an exemplary sensor device 200 and user devices 300 in immediate, near, far, and unknown ranges of the sensor device 200. For example, the signal strength of the wireless beacon signal received by the user device 300 in the immediate range of the sensor device 200 can be highest and representative of the device 300 being physically very close to the sensor device 200. The signal strength of the wireless beacon signal received by the user device 300 in the near range of the sensor device 200 can be the next highest and representative of the device 300 being within a clear line of sight of the sensor device 300. The signal strength of the wireless beacon signal received by the user device 300 in the far range of the sensor device 200 can be the lowest and representative of the device 300 not being physically near the sensor device 200 or an obstruction existing between the sensor device 200 and the user device 300 that causes attenuation of the signal. In some embodiments, the signal strength of the wireless beacon signal received by the user device 300 in the far range of the sensor device 200 can also be representative of low confidence in the accuracy of location detection. Finally, the signal strength of the wireless beacon signal received by the user device 300 in an unknown range may be unable to be determined and representative of a detectable range just beginning or of insufficient signal measurements to determine range.

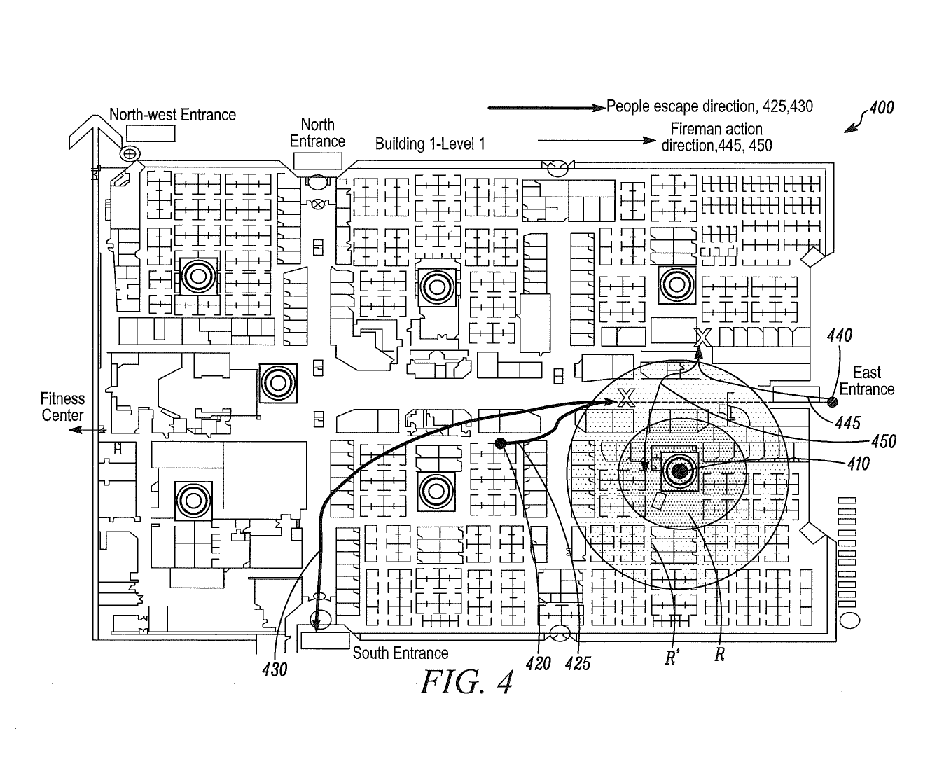

FIG. 4 is a floor plan 400 of a monitored region in accordance with disclosed embodiments. As seen in FIG. 4, a sensor 410 in the region that detects an emergency condition can transmit an alarm signal and a wireless beacon signal with ranges R and R′. The signal strength of the signal in range R can be higher than the signal strength of the signal in range R′. The floor plan 400 and paths 425, 430, 445, 450 shown thereon are illustrative of users 420, 440, such as occupants exiting the region and emergency personnel entering the region to address the detected emergency, effectively traversing the region to avoid or approach the sensor 410 that detected the emergency condition.

For example, upon hearing the alarm signal, a user 420 in the region can try to exit the region via the East Entrance along the path 425. However, as the user 420 moves along path 425, the user's electronic device can enter the range R′ of the sensor 410 and receive the wireless beacon signal transmitted by the sensor 410. Upon receipt of the wireless beacon signal, the user 420 can change direction and exit the region via the South Entrance along the path 430. While traversing the path 430, the user's electronic device does not receive the wireless beacon signal so the user 420 can understand that he is always a relatively safe distance away from the emergency condition detected by the sensor 410.

Conversely, emergency personnel 440 can enter the region via the East Entrance and try to locate the sensor 410 by traversing path 445. However, as the emergency personnel 440 moves along path 445, the emergency personnel's electronic device can enter and then exit the range R′ of the sensor 410 and accordingly, receive and then stop receiving the wireless beacon signal transmitted by the sensor 410. Upon exiting the range R′ of the sensor 410 and failing to receive the wireless beacon signal transmitted by the sensor 410, the emergency personnel can change direction and traverse the path 450 so that the emergency personnel's electronic device reenters the range R′ and then the range R of the sensor 410 and accordingly, receives the wireless signal transmitted by the sensor with a signal strength at a progressively higher level. Accordingly, the user can understand that he is moving in the right direction and getting closer to the emergency condition detected by the sensor 410.

Although a few embodiments have been described in detail above, other modifications are possible. For example, the logic flows described above do not require the particular order described, or sequential order, to achieve desirable results. Other steps may be provided, or steps may be eliminated, from the described flows, and other components may be added to, or removed from, the described systems. Other embodiments may be within the scope of the invention.

From the foregoing, it will be observed that numerous variations and modifications may be effected without departing from the spirit and scope of the invention. It is to be understood that no limitation with respect to the specific system or method described herein is intended or should be inferred. It is, of course, intended to cover all such modifications as fall within the spirit and scope of the invention.

1. A method comprising:
detecting an ambient emergency condition; and
responsive to detecting the ambient emergency condition, transmitting a wireless beacon signal for detection by an electronic device,
wherein a range into which the wireless beacon signal is transmitted is limited, and
wherein a signal strength of the wireless beacon signal progressively decreases from a first part of the range, adjacent a source of the wireless beacon signal, to a second part of the range, displaced from the source of the wireless beacon signal, and
wherein the electronic device changes direction towards or away from the source of the wireless beacon signal when the electronic device is in the second part of the range based on a current user type for the electronic device.

2. The method of claim 1, wherein the wireless beacon signal includes a Bluetooth Low Energy advertising message.

3. The method of claim 1, further comprising abstaining from transmitting the wireless beacon signal prior to detecting the ambient emergency condition.

4. (canceled)

5. The method of claim 1 further comprising ceasing transmitting transmission of the wireless beacon signal after failing to detect the ambient emergency condition for a predetermined period of time after detecting the ambient emergency condition.

6. The method of claim 1 further comprising transmitting the wireless beacon signal until a user input with instructions to cease transmitting the wireless beacon signal is received by the source of the wireless beacon signal.

7. The method of claim 1, wherein the wireless beacon signal includes information about a sensor device that detected the ambient emergency condition.

8. The method of claim 1, wherein the wireless beacon signal includes information about the ambient emergency condition.

9. The method of claim 1, further comprising separately reporting the ambient emergency condition to an alarm monitoring system.

10. A method comprising:
an electronic device detecting and receiving a wireless beacon signal from a sensor device;
determining a signal strength of the wireless beacon signal; and
based on the signal strength, determining a range of the sensor device,
wherein the signal strength of the wireless beacon signal progressively decreases from a first part of the range, adjacent the sensor device, to a second part of the range, displaced from the sensor device, and
wherein the electronic device is directed to change direction towards or away from the sensor device when the electronic device is in the second part of the range based on a current user type for the electronic device.

11. The method of claim 10, wherein the wireless beacon signal includes a Bluetooth Low Energy advertising message.

12. The method of claim 10 further comprising failing to receive the wireless beacon signal outside of the range of the sensor device.

13. The method of claim 10 further comprising decoding the wireless beacon signal to identify additional information about the sensor device.

14. The method of claim 10 further comprising decoding the wireless beacon signal to identify additional information about an ambient emergency condition detected by the sensor device.

15. The method of claim 10 further comprising categorizing the range of the sensor device.

16. The method of claim 10 further comprising the electronic device displaying or emitting a notification message indicative of the range of the sensor device.

17. A system comprising:
a sensing device;
a transceiver;
one or more programmable processors; and
executable control software stored on a non-transitory computer readable medium,
wherein, responsive to the sensing device detecting an ambient emergency condition, the programmable processor and the executable control software cause the transceiver to transmit a wireless beacon signal into a limited range for detection by an electronic device,
wherein a signal strength of the wireless beacon signal progressively decreases from a first part of the limited range, adjacent the transceiver, to a second part of the limited range, displaced from the transceiver, and
wherein the electronic device changes direction towards or away from the sensing device when the electronic device is in the second part of the limited range based on a current user type for the electronic device.

18. The system of claim 17, wherein the wireless beacon signal includes a Bluetooth Low Energy advertising message.

19. The system of claim 17, wherein the programmable processor and the executable control software abstain from causing the transceiver to transmit the wireless beacon signal prior to the sensing device detecting the ambient emergency condition.

20. The system of claim 17
wherein the electronic device determines the signal strength of the wireless beacon signal, and
wherein, based on the signal strength, the electronic device determines the limited range of the sensing device.
